(19) United States
(12) Patent Application Publication
(10) Pub. No.: US 2013/0130362 A1
(43) Pub. Date: May 23, 2013

(54) POWER SPECTRAL DENSITY CHEMICAL AND BIOLOGICAL SENSOR

(71) Applicant: Applied sensor research & development corporatio, Arnold, MD (US)

(72) Inventors: Jacqueline H. HINES, Annapolis, MD (US); Leland P. SOLIE, Apopka, FL (US)

(73) Assignee: APPLIED SENSOR RESEARCH & DEVELOPMENT CORPORATION, Arnold, MD (US)

(21) Appl. No.: 13/679,607

(22) Filed: Nov. 16, 2012

Related U.S. Application Data
(60) Provisional application No. 61/561,571, filed on Nov. 18, 2011.

(51) Int. Cl. G01N 29/024

(52) U.S. Cl. CPC G01N 29/024
USPC 435/287.1; 422/68.1

(57) ABSTRACT

A surface acoustic wave (SAW) based sensor device and system for detecting the presence of and measuring the concentration of chemical and biological analytes in vapor and liquid phase can include inherent temperature compensation and the capability to operate in a wired mode or in a wireless mode with the ability to measure the distance of the sensor from the wireless transceiver (in addition to measuring temperature and the chemical and/or biological analytes of interest). This device can also monitor changes in state of thin films, including but not limited to sensing glassy to rubbery transitions in polymers, and measurement of the kinetics of chemical and/or biological processes occurring at the surface of the device. Coding, time, and frequency diversity can be included in the device structure to enable production of groups of individually identifiable sensor devices capable of operating simultaneously within the field of view of a wireless transceiver.

### CROSS REFERENCE TO RELATED APPLICATION

This application claims the benefit of, and priority to, U.S. provisional application No. 61/561,571, filed on Nov. 18, 2011, herein incorporated by reference in its entirety.

### STATEMENT REGARDING FEDERALLY SPONSORED RESEARCH OR DEVELOPMENT

This invention was made with Government support under contract NNX09CB77C awarded by the National Aeronautics and Space Administration (NASA). The Government may have certain rights in the invention.

### FIELD OF THE INVENTION

The present invention relates generally to the monitoring of physical, chemical, and biological properties of various fluids, polymers, and composite thin film materials. As used herein the term “fluid” refers broadly to both liquids and gases composed of one chemical element or compound, and/or mixtures composed of more than one component, including gaseous or liquid solutions, colloids, suspensions, and other heterogeneous phase mixtures. The present invention relates more particularly to the detection, identification, and quantitation of particular chemical or biological species in the sample being measured, and determination of physical properties of the sample such as temperature, pressure, and viscosity, among others; and in particular to apparatus, systems, devices, and methods for monitoring such materials and analyzing the properties thereof using surface acoustic wave technology.

### BACKGROUND AND BRIEF DESCRIPTION OF THE RELATED ART

Detecting the presence and measuring the concentration of certain chemical and biological substances is significant in a wide range of applications, including but not limited to industrial process control, agricultural and food production, vehicle condition monitoring, environmental contamination monitoring, and human and veterinary medicine applications such as anesthesia monitoring and clinical diagnostics. Being able to provide real-time information on composition of fluids, and to simultaneously provide physical parameter measurements such as temperature, pressure, flow, and viscosity of the fluid and/or measurements of the surrounding system such as temperature, pressure, and strain, enables optimization of system operation across these disparate applications. Real-time monitoring of the characteristics and properties of thin films, and the interactions of such films with fluids, may also enable tools suitable to study the reaction kinetics of chemical and biological processes necessary for drug discovery and evaluation of efficacy, and a wide range of other fundamental investigations.

### I. BACKGROUND

Sensors based on surface-launched acoustic wave devices have been developed since the 1980's for application to physical measurements (temperature, pressure, torque, strain, etc.) and to a wide range of chemical and biological detection problems (see, the thirty-five references cited herein). These widely varying devices have utilized several operating modes and corresponding wave propagation modes, including the traditional Rayleigh wave (or Surface Acoustic Wave (SAW)), the surface transverse wave (STW), the surface skimming bulk wave (SSBW), the SSBW that has been guided to the surface via a layer, known as the Love wave, the shear-horizontally polarized acoustic plate mode (SH-APM), the flexural plate wave (FPW) or Lamb wave, the layer guided acoustic plate mode (LG-APM), and the thickness shear mode (TSM) bulk wave (as used in quartz crystal microbalance—QCM devices), and the layer guided shear horizontal acoustic plate mode (LG-SHAPM). A number of different device types have been recognized using these diverse wave modes, including resonators, delay lines, differential delay lines, and reflective delay lines (tag or ID devices). These devices have been operated within a wide range of wired and wireless interrogation system architectures, which have generally been designed specifically to operate with the selected sensor(s). In most cases, wireless interrogation has been applied to physical sensors, and not to biological or chemical sensors. These system architectures include pulsed (dispersive of non-dispersive) radar-like delay measurement systems (Reindl, L. M., et. al., “SAW-Based Radio Sensor Systems,” IEEE Sensors Journal, Vol. 1, No. 1, pp. 69-78, June 2001; U.S. Pat. No. 6,144,332 to Reindl et. al.), Fourier transform measurement systems (Hamsch, M., et. al., “Temperature measurement system and wireless SAW sensors,” IEEE Transactions on Ultrasonics, Ferroelectrics, and Frequency Control, Vol. 51, No. 11, pp. 1449-1456, November 2004), and delay line and resonator-based oscillator systems (Buff, W., et. al., “Universal pressure and temperature SAW sensor for wireless applications,” Proceedings of the 1997 IEEE Ultrasonics Symposium, pp. 359-362; Pohl, A., and L. Reindl, “Measurement of physical parameters of car tires using passive SAW sensors,” AMAA 1998, Berlin Germany; U.S. Pat. No. 4,312,228 to Wohltjen). A time-integrating correlator based interrogation system has recently been introduced by the inventors of the present invention (U.S. Pat. No. 7,434,989 to Solie; U.S. Pat. No. 7,268,662 to Hines). The system architecture has usually been selected based on specific device characteristics and application requirements, and generally involves absolute or differential measurements of sensor frequency, phase, delay, amplitude, or power spectral density, and changes in these quantities with exposure, to provide the output sensor measurement. Historically, signal amplitude has only been used as a measurand for devices operated in a wired mode, due to the variation in response amplitude caused by changes in distance between the interrogation system and the sensor(s).

The relative advantages of each wave mode and device type make them suitable for different applications. Rayleigh wave sensors, for instance, involve particle displacements that include a component normal to the substrate surface. When used in a liquid, this component generates a compressional wave in the liquid, causing wave energy to leak into the liquid. This energy leakage results in large attenuation of the Rayleigh wave, often referred to as “damping”. This effect makes Rayleigh waves useful only for gas phase sensing, and not applicable to sensing in the liquid phase. This energy leakage occurs whenever the wave motion in the substrate involves a component of displacement normal to the substrate surface, and the speed of the sound wave in the device is greater than the speed of sound in the liquid (or in the layer coating the device). Certain wave modes, such as flexural plate waves (FPWs), do involve a normal component of displacement, but have wave velocities lower than the speed of sound in the liquid. Leakage therefore does not occur, and FPW devices can operate successfully in liquid environments. Other wave modes that do not involve components of displacement normal to the substrate surface are also operable in both gas and liquid phase. These include Love waves, STW, SH-APM, and LG-APM, LG-SH-APM.

Rayleigh waves coated with polymers have been used extensively for chemical vapor detection. QCM devices have also been applied to characterization of interfacial chemistry in both vapor and liquid environments (Thompson book). In recent years, there has been significant research into the application of STW, APM, FPW, and Love waves to liquid based biosensing (the references listed below represent a small sample of relevant publications).
Baer, R. L., Costello, B. J., Wenzel, S. W., and White, R. M., “Phase noise measurements of flexural plate wave sensors,” Proceedings of the 1991 IEEE Ultrasonics Symposium, pp. 321-326.
Costello, B. J., Martin, B. A., and White, R. M., “Acoustic plate-wave biosensing”, Proceedings of the IEEE Engineering in Medicine and Biology Society 11^{th} Annual International Conference, 1989.
Costello, B. J., Martin, B. A., and White, R. M., “Ultrasonic plate waves for biochemical measurements”, Proceedings of the 1989 IEEE Ultrasonics Symposium, pp. 977-981.
Costello, B. J., Wenzel, S. W., Wang, A., and White, R. M., “Gel-coated Lamb wave sensors”, Proceedings of the 1990 IEEE Ultrasonics Symposium, pp. 279-283.
Dabirikhah, H., and Turner, C. W., “Anomalous behaviour of flexural plate waves in very thin immersed plates”, Proceedings of the 1992 IEEE Ultrasonics Symposium, pp. 313-317.
McHale, G., Newton, M. I., and Martin, F., “Layer guided shear horizontally polarized acoustic plate modes”, Journal of Applied Physics, Vol. 91, No. 9, 1 May 2002, pp. 5735-5744.
Wang, Z., Jen, C.-K., and Cheeke, D. N., “Analytical solutions for sagittal plane waves in three-layer composites”, IEEE Transactions on Ultrasonics, Ferroelectrics and Frequency Control, Vol. 40, No. 4, July 1993, pp. 293-301.
Wang, Z., Jen, C.-K., and Cheeke, D. N., “Mass sensitivities of shear horizontal waves in three-layer plate sensors”, IEEE Transactions on Ultrasonics, Ferroelectrics and Frequency Control, Vol. 41, No. 3, May 1994, pp. 397-401.
Wenzel, S. W. and White, R. M., “A multisensor employing an ultrasonic Lamb-wave oscillator”, IEEE transactions on Electron Devices, Vol. 35, No. 6, June 1988, pp. 735-743.
Wenzel, S. W. and White, R. M., “Flexural plate wave sensor: Chemical vapor sensing and electrostrictive excitation”, Proceedings of the 1989 IEEE Ultrasonics Symposium, pp. 595-598.
Wenzel, S. W., Martin, B. A., and White, R. M., “Generalized Lamb-wave multisensor”, Proceedings of the 1988 IEEE Ultrasonics Symposium, pp. 563-567.
White, R. M., Wicher, P. J., Wenzel, S. W., and Zellers, E. T., “Plate-mode ultrasonic oscillator sensors”, IEEE Transactions on Ultrasonics, Ferroelectrics and Frequency Control, Vol. 34, No. 2, March 1987, pp. 162-171.
Gizeli, E., Stevenson, A. C., Goddard, N. J., and Lowe, C. R., “A novel Love-plate acoustic sensor utilizing polymer overlayers”, IEEE Transactions on Ultrasonics, Ferroelectrics, and Frequency Control, Vol. 39, No. 5, September 1992, pp. 657-659.
Dahint—1997 FCS Immunosensor paper.
Dahint, R., Bender, F., and Morhard, F., “Operation of acoustic plate mode immunosensors incomplex biological media”, Anal. Chem. Vol. 71, 1999, pp. 3150-3156.
Zimmermann, C., Rebiere, D., Dejous, C., Pistre, J, and Chastaing, E., “Evaluation of Love waves chemical sensors to detect organophosphorous compounds: comparison to SAW and SH-APM devices”, Proceedings of the 2000 IEEE International Frequency Control Symposium, pp. 47-51.
Newton—electronic letters 2001 harmonic love wave.

Love waves are often cited as having the highest possible mass sensitivity (Gizeli, E., Stevenson, A. C., Goddard, N. J., and Lowe, C. R., “A novel Love-plate acoustic sensor utilizing polymer overlayers”, IEEE Transactions on Ultrasonics, Ferroelectrics, and Frequency Control, Vol. 39, No. 5, September 1992, pp. 657-659). STW devices have the practical drawback of difficulty of creating a physical interface between the fluid (liquid or gas) sample chamber and the active device surface. In STW devices, the fluid must be constrained to interact with the surface of the device on which the wave is generated and propagates. This involves making a liquid or gas tight contact on the substrate surface without interfering with the generation and propagation of the acoustic wave. FPW, APM, and LG-APM devices, by comparison, have an advantage in that a gas or liquid sample can interact with the back side of the device, leaving the wave generation process (on the front side of the device) unaffected.

Most FPW devices reported have been fabricated using silicon substrates with deposited surface layers with desired properties. The Silicon substrates are then etched away in the region beneath the sensor active region, leaving a membrane consisting of the surface layer only. These layers may be composed of various films, and the backside of the device may be used to allow exposure of the device to liquid samples, while keeping the electrical connections of the device separated from the sample. Typical films consist of a structural component such as silicon nitride (Si₃N₄), combined with a ground electrode layer (often aluminum), followed by a piezoelectric film layer such as zinc oxide (ZnO), and surface fabricated electrodes (Costello, B. J., Martin, B. A., and White, R. M., “Acoustic plate-wave biosensing”, Proceedings of the IEEE Engineering in Medicine and Biology Society 11^{th} Annual International Conference, 1989). Composite layer thicknesses typically range from around 3 microns to around 6 microns in thickness, and the resulting devices have operating frequencies in the low MHz range.

APM devices, by comparison, have generally been fabricated from plates of piezoelectric materials, often using the thickness of standard wafers. Typical devices may utilize substrates with thickness of 0.5 mm (20 mils). APM devices have been demonstrated on quartz and on high coupling substrates such as lithium niobate. Typical APM devices operate in the low hundred MHz range (Dahint—1997 FCS Immunosensor paper; Dahint, R., Bender, F., and Morhard, F., “Operation of acoustic plate mode immunosensors incomplex biological media”, Anal. Chem. Vol. 71, 1999, pp. 3150-3156; Zimmermann, C., Rebiere, D., Dejous, C., Pistre, J, and Chastaing, E., “Evaluation of Love waves chemical sensors to detect organophosphorous compounds: comparison to SAW and SH-APM devices”, Proceedings of the 2000 IEEE International Frequency Control Symposium, pp. 47-51).

Love wave devices consist of a substrate and a top layer that acts as a guiding layer for the acoustic wave. Generally, the substrate is piezoelectric, such as quartz, and the guiding layer is made of a material with a sound speed lower than the wave speed in the substrate. On quartz, amorphous SiO2 and various polymers (PMMA, etc.) are often utilized as the guiding layer. Standard thickness piezoelectric substrates are generally used, with varying thicknesses of guiding layers based on device design. Fundamental and harmonic device operation have been evaluated, resulting in operating frequencies ranging from roughly 100 MHz to over 300 MHz (Newton—electronic letters 2001 harmonic love wave).

Finally, layer-guided SH-APMs have been identified as shear horizontally polarized waves that occur in a system that consists of a finite substrate covered by a finite guiding layer of slower shear acoustic speed, and are analogous to either Love waves or to SH-APMs, depending on the precise structure of the device under consideration. It has been suggested that these devices will be capable of higher mass sensitivity than other previously identified device structures (McHale, G., Newton, M. I., and Martin, F., “Layer guided shear horizontally polarized acoustic plate modes”, Journal of Applied Physics, Vol. 91, No. 9, 1 May 2002, pp. 5735-5744), and biosensor devices have exploited this high sensitivity (U.S. Pat. No. 7,500,379 to Hines).

Due to the sensitivity of surface-launched acoustic wave sensors to changes in environmental parameters, it has been customary to utilize some sort of reference signal in the sensors or a reference device in the sensor systems. This has been accomplished in various ways. For example, differential delay line devices have been used to eliminate variations in electronic signals common to both delay paths, resulting in sensors that are only sensitive to variations in temperature (U.S. Provisional Patent Applications Nos. 61/512,309, 61/151,884, and 61/512,883 to Hines regarding SAW deposition monitor for ultra-thin films, July 2011 (not yet published); Malocha, D. C., D. Puccio, and D. Gallagher, “Orthogonal Frequency Coding for SAW Device Applications,” Proceedings of the 2004 IEEE International Ultrasonics, Ferroelectrics, and Frequency Control Symposium, Montreal Calif., August 2004; U.S. Pat. No. 6,144,332 to Reindl et. al.). Similarly, pressure sensors have been developed that utilize multiple transducer and/or reflector structures with wave propagation at different orientations on the substrate to provide information about temperature simultaneously with information about pressure, allowing for the unambiguous determination of both parameters using a single sensor device (Malocha, D. C., D. Puccio, and a Gallagher, “Orthogonal Frequency Coding for SAW Device Applications,” Proceedings of the 2004 IEEE International Ultrasonics, Ferroelectrics, and Frequency Control Symposium, Montreal Calif., August 2004; Puccio, D., D. C. Malocha, D. Gallagher, and J. Hines, “SAW Sensors Using Orthogonal Frequency Coding,” Proceedings of the 2004 IEEE International Ultrasonics, Ferroelectrics, and Frequency Control Symposium, Montreal Calif., August 2004; Hines, J. H., NASA Contract Number NNX10CD41P, “Rapid Hydrogen and Methane Sensors for Wireless Leak Detection”, Phase I SBIR Final Report, 29 Jul. 2010; Hines, J. H., NASA Contract Number NNX09CB77C, “Passive Wireless SAW Humidity Sensors and System”, Phase II STTR Final Report, 18 November, 2011). SAW-based chemical vapor sensor systems have historically utilized multiple polymer-coated SAW sensor devices in an array configuration. Polymers were selected for their chemical orthogonality, or their ability to selectively adsorb or absorb chemical vapors of interest. Patterns of vapor responses developed on the multi sensor arrays could then be characterized using pattern recognition techniques. Reference sensors that were hermetically sealed or otherwise protected from exposure to the vapors under test were generally included in the arrays in order to allow for accurate determination of the array response. These arrays were often temperature controlled, either through bulk temperature control of the sensor devices (using under package heating and cooling) or through on-chip heaters incorporated in the sensor devices (Sawtek Inc. internal reports (not published)). These temperature control elements (including on-chip heaters) could be used to thermally ramp sensors and observe the temperature (and thus time) dependent desorption of adsorbed of vapors, providing an additional metric useful for pattern recognition (Sawtek Inc. internal reports (not published)). Prior biosensor devices have generally been used individually or in pairs, where one device serves as a reference device for the pair. In most cases where arrays of sensors have been used in biological and/or chemical sensing, the array has been composed of multiple individual distinct sensor devices along with measurement electronics (the exception being (U.S. Pat. No. 7,500,379 to Hines)). Depending on the system configuration, the measurement electronics may be common (“shared” and used sequentially by all sensors in the array), or multi-channel electronics may be used, allowing the simultaneous (or near-simultaneous) measurement of all array elements.

Prior SAW based RF ID tags and physical sensors (including Malocha, D. C., D. Puccio, and D. Gallagher, “Orthogonal Frequency Coding for SAW Device Applications,” Proceedings of the 2004 IEEE International Ultrasonics, Ferroelectrics, and Frequency Control Symposium, Montreal Calif., August 2004; Puccio, D., D. C. Malocha, D. Gallagher, and J. Hines, “SAW Sensors Using Orthogonal Frequency Coding,” Proceedings of the 2004 IEEE International Ultrasonics, Ferroelectrics, and Frequency Control Symposium, Montreal Calif., August 2004; Hines, J. H., NASA Contract Number NNX10CD41P, “Rapid Hydrogen and Methane Sensors for Wireless Leak Detection”, Phase I SBIR Final Report, 29 Jul. 2010; Hines, J. H., NASA Contract Number NNX09CB77C, “Passive Wireless SAW Humidity Sensors and System”, Phase II STTR Final Report, 18 November, 2011) have utilized various coding techniques to allow identification of individual sensors within multisensor networks. Such sensors have also been accessed primarily via wireless radio frequency (RF) communication techniques. The ability to incorporate unique sensor identification and the potential wireless operation aspect of these sensors has not been exploited for chemical and biological sensing applications in vapors and liquids.

### SENSOR EMBODIMENT

Surface launched acoustic wave chemical and biological sensor device embodiments have historically been intended for use in wired measurement systems, and have not included coding, frequency, or time diversity to generate multiple individually identifiable sensors. The most well known SAW chemical and biological sensor devices also involve absolute or differential measurements of sensor frequency, phase, delay, amplitude, or power spectral density, and changes in these quantities with exposure, to provide the output sensor measurement. Historically, signal amplitude has only been used as a measurand for devices operated in a wired mode, due to the variation in response amplitude caused by changes in distance between the interrogation system and the sensor(s). Typical SAW wireless sensor systems utilized differential frequency measurements, or differential delay measurements (one example of which is in U.S. Pat. No. 6,144,332 to Reindl et. al.).

A detailed description of devices that involve absolute or differential measurements of sensor frequency, phase, delay, and amplitude will not be included herein, as these have been widely reported for two decades in wired and wireless applications. A more detailed discussion of power spectral density based sensors is included in order to address the differences between these sensors and the present invention.

Patents previously issued to the inventors of the current invention teach a SAW-based sensor and system suitable for wired or wireless determination of hydrogen vapor concentration and/or temperature, based on changes in features of the power spectral density (PSD) of the sensor response (see U.S. Pat. No. 7,434,989 to Solie, and U.S. Pat. No. 7,268,662 to Hines). It has been established that SAW devices with three acoustic wave elements including at least one transducer can be constructed to produce two responses that are closely spaced in time, resulting in a train of notches in the frequency domain separated by the inverse of the delay difference in responses, windowed by the bandpass function produced by the SAW transducer and reflector elements. FIG. 1 illustrates idealized versions of the responses described. FIG. 1(a) shows two idealized impulse responses 100 in the time domain, separated by a time spacing Δt (102). FIG. 1(b) shows the (positive) frequency spectrum corresponding to the Fourier transform of the signal in FIG. 1(a), which consists of a train of nulls 106 separated in frequency by spacing 1/Δt (108). FIG. 1(c) shows how this train of nulls would change as the amplitude of the two impulses varies, and as the time separation of the two impulses 102 varies. When both impulses are of equal amplitude, as shown in FIG. 1(a), with time spacing Δt (102), the frequency response is a train of deep nulls 112. As the amplitudes of the two impulses become unequal, the nulls become shallower and less distinct 114, until when one of the impulses disappears the response becomes constant 116. If the two impulses have equal amplitudes, but the spacing Δt (102) decreases, the nulls in frequency become spaced further apart 118. In a practical implementation of these responses in a SAW device, windowing is produced by the SAW transducers. FIG. 1(d) shows idealized window functions 120 and 122, where the two window functions together create a bandpass filter. As shown in FIG. 1(d), window function 120 is centered on a peak of the frequency response, while window function 122 is centered on the adjacent null of the frequency response. FIG. 1(e) shows an idealized version of the response that would be produced by implementing such a structure in a SAW device. Given the frequency alignment of the two window functions, 120 produces a peak 124, while 122 produces a low response 126. The relative amplitude of the responses in the two half passbands (which together make up one overall passband) provides information about the positions and depths of the nulls in the frequency response.

Proper selection of the device passband (made up of half passbands 120 and 122) and time separation Δt (102) produces a device with one or more nulls in the passband. As the time separation between impulses varies, the string of nulls “accordians” in and out, with the DC end pinned. The sensitivity of the device can be varied by selecting the appropriate separation Δt (102), and by selecting at which null to operate. Nulls farther away from DC move faster for a given change in separation Δt. In addition, for a fixed passband, as the separation Δt (102) varies, the number of nulls in the passband can change. Also, as the relative amplitudes of the two impulses change, the depth and sharpness of the nulls changes. It should be noted that this technique can be extended to utilize multiple passbands rather than simply two window functions as shown in FIG. 1(d), to provide more detailed information about notch location and movement.

In practice, the actual notches produced can be significantly sharper and narrower than shown in FIG. 1. For example, FIG. 2 shows a measured response (126) for a simple SAW device according to this structure. In this particular device, the single notch (128) in the device passband is quite narrow and more than 45 dB in depth. Single null devices are often desired, although devices can be designed to have various numbers of nulls in the passband, and null depths and frequencies. On prior embodiments, the delay differences that determine the notch frequency and separation have been designed into the devices based on the distances between transduction and/or reflection elements. For useful devices, this generally means the two delays are different by a small delay, resulting in a single notch in the SAW passband frequency range.

Another recent invention utilizes SAW differential delay line devices with equal to significantly differing delays, that when combined with the films being deposited provide measurable changes in device response based on film deposition and properties. FIG. 3 shows one such simple device configuration 140. In this embodiment, the sensor can operate in two ways. In the first operational mode (shown in FIG. 3(a)), the device consists of a piezoelectric substrate (also called a die) 142, on which are formed at least three SAW elements, at least one of which is a transducer. In FIG. 3(a), the center SAW element 144 is a transducer, which serves to receive an exciting signal from an input/output antenna 146. Alternatively, these devices can operated in a wired configuration without an antenna. Transducer 144 converts the input electrical signal into a surface acoustic wave signal, that propagates outward in both directions on the surface of the die. Reflections of the acoustic wave from the two outer SAW elements 148 and 150 (which are shown in this example as transducers, but can be reflectors or transducers) are combined at the center transducer 144, producing an output signal that is transmitted through antenna 146 or alternatively through a direct electrical connection such as a coaxial cable. The reflection from the left SAW element 150 reaches the output port of device 140 at a delay t1, while the reflection form the right SAW element 148 reaches the output port of device 140 at a delay t2. Times t1 and t2 are selected to produce the desired starting separation Δt. In the second operating mode (shown in FIG. 3(b)), device 160 consists of a piezoelectric substrate (or die) 162, on which are formed at least three SAW elements, at least one of which is a transducer. In FIG. 3(b), the center SAW element 164 is a transducer, as are the two outer SAW elements 168 and 170. All three transducers (164, 168, and 170) are electrically connected to a means to provide electrical excitation and to receive the device response, shown in this example by an input/output antenna 166, which is electrically connected to all three said transducers in parallel. Alternatively, these devices can be operated in a wired configuration without an antenna. Transducer 164 converts the input electrical signal into a surface acoustic wave signal, that propagates outward in both directions on the surface of the die. At the same time, transducers 168 and 170 excite acoustic waves (either bidirectionally or preferentially in a unidirectional manner towards transducer 164). As the SAW device response is reciprocal, the signal from the acoustic wave launched by 164 and received by 168 is equal to that launched by 168 and received by 164. Likewise, the signal from the acoustic wave launched by 164 and received by 170 is equal to that launched by 170 and received by 164. All four of these signals are combined at the common output means 166, producing an output signal that is transmitted through antenna 166 or alternatively through a direct electrical connection such as a coaxial cable. The portion of the response from SAW elements 164 and 170 reaches the output port of device 160 at a delay t1, while the portion of the response from SAW elements 164 and 168 reaches the output port of device 140 at a delay t2. As before, times t1 and t2 are selected to produce the desired separation Δt.

U.S. Provisional Patent Applications Nos. 61/512,309, 61/151,884, and 61/512,883 entitled “SAW deposition monitor for ultra-thin films”, and U.S. Utility patent application Ser. No. 13/485,317 entitled “Surface Acoustic Wave monitor for deposition and analysis of ultra-thin films”, filed previously by one of the inventors of the present invention, teach a thin film deposition monitor device that utilizes changes in the notched PSD response of a device to provide real-time information on the properties of thin films as they are deposited. FIG. 4 shows the measured time domain response of a simple SAW deposition monitor according to this prior invention. The starting condition of the device response is shown by the curve (172) on FIG. 4, and consists of two peaks in time, which correspond to the acoustic wave reflections from the two reflective structures at either end of the SAW device (shown in FIG. 3a). As the thickness of the film being deposited increased, the second peak in the time domain response shown in FIG. 1 changed from −44 dB down to −55 dB after one second (174), down to more than −100 dB (in the noise) after 2 seconds, and then came back up to −45 d13 (176) after 3 seconds. For this particular film deposition run, this happened in a period of less than 4 seconds. Other deposition runs performed at lower deposition rates showed more gradual changes. Note in FIG. 4 that the reference peak in time (178) provides a built-in reference. Changes in device temperature would produce shifts in the delay of this reference device. This can be used to calibrate the devices for film thickness at varying deposition temperatures. The changes in the second peak relative to the reference peak can be used to determine the film response.

FIG. 5 shows the frequency domain response (180) measured for the device whose time domain response is shown in FIG. 4. The device in the initial state, prior to film deposition, has three sharp nulls (182) in the passband region. As in the time domain response, drastic changes in the frequency domain response are observed with minute incremental film deposition steps. After 1 second of deposition, the nulls have all become very shallow and poorly defined (184), as the device is in transition between having three and four nulls. After 2 seconds, the device has four sharp nulls in the passband. And after 3 seconds, a fifth null is entering the passband region from the high frequency side.

The size of the changes observed in the frequency response notches, both in amplitude (i.e. notch depth) and in frequency, are quite large. Notches vary by over 40 dB in depth, and by many MHz in frequency in the simple example shown in FIG. 5. The time resolution of the measurement system used for data collection in this preliminary experiment limited sample rate to 1 sample per second. Alternate wired and wireless interrogation systems are possible that can provide much faster data acquisition, easily up to one sample every 10 msec (100 Hz sampling), and possibly considerably higher rates depending on other system performance factors required.

### II. BRIEF DESCRIPTION OF THE FIGURES

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, where like reference numerals refer to like reference in the specification:

FIG. 1 depicts an idealized representation of the approach used in PSD sensors.

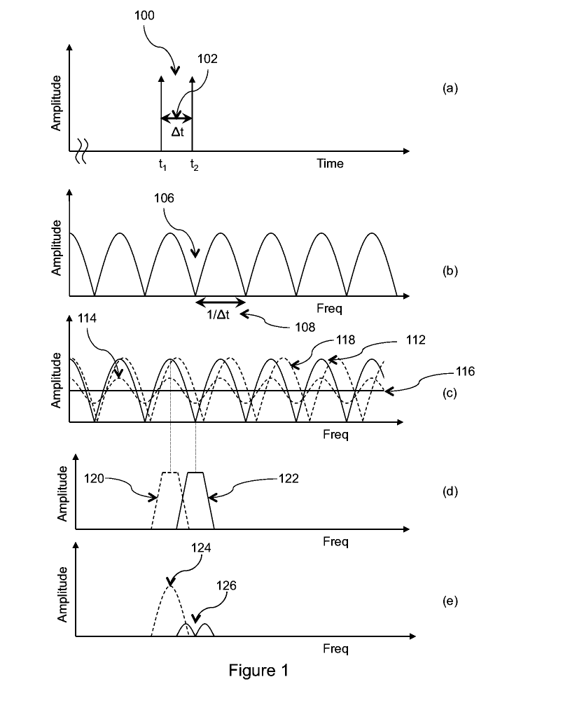

FIG. 2 is an experimental example of the measured frequency response of a SAW differential delay line film deposition monitor device, with a single notch (more than 45 dB in depth) in the passband.

FIG. 3 shows a schematic representation of two embodiments of a temperature compensated film deposition monitoring and analysis device. These devices can also be used independently as temperature sensors (with or without the added surface films).

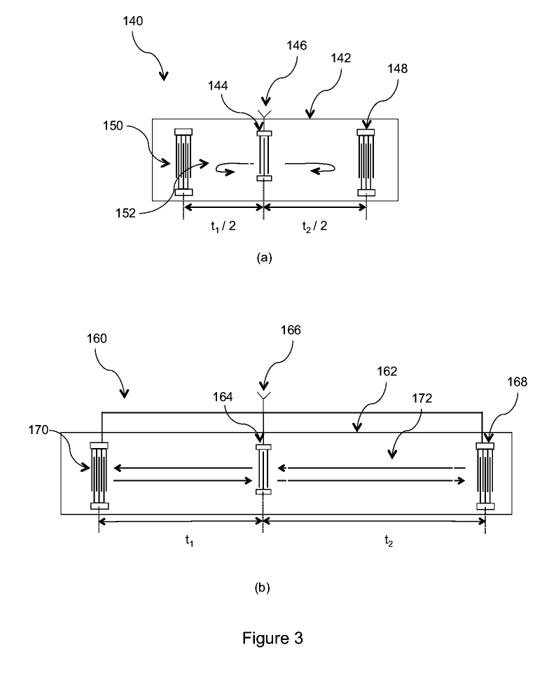

FIG. 4 shows the experimental time lapse response of an in-situ SAW deposition monitor during e-beam deposition of an ultrathin Palladium (Pd) film. The film measured 14 angstroms on the QCM monitor, and was deposited over only 4 seconds. Note that this response (in the time domain) has a reference signal (the peak on the left, which remains unchanged during the deposition), and a measurement peak that changes during exposure (on the right).

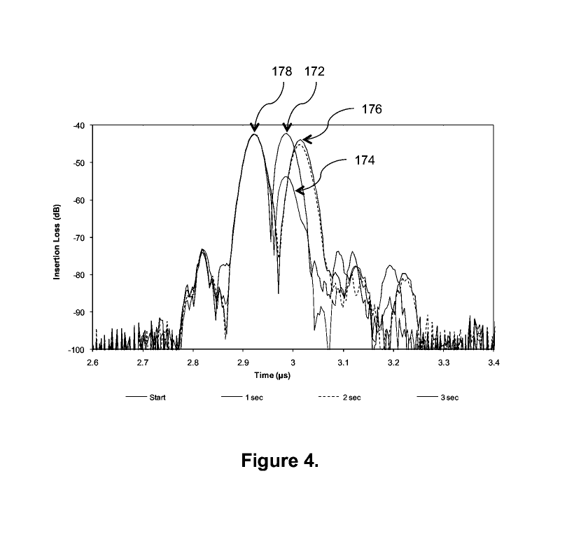

FIG. 5 shows the frequency domain responses corresponding to the time domain responses of the deposition monitor shown in FIG. 4.

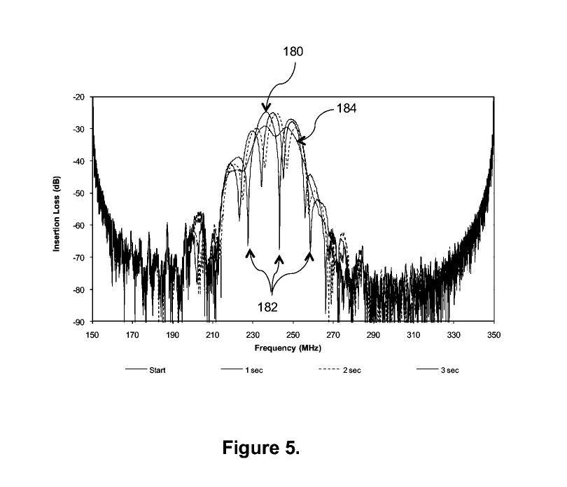

FIG. 6 shows a schematic representation of a simple attenuation-based sensor according to the present invention.

FIG. 7 shows a schematic representation of a coded, two acoustic track differential delay line sensor according to the present invention that utilizes tapered transducers.

FIG. 8 provides a schematic of a simplified time integrating correlator-based transceiver system suitable to read sensors according to the present invention.

FIG. 9 is experimental data of a humidity sensor according to the present invention.

FIG. 10 is a schematic illustrating one embodiment of the present invention comprising multiple acoustic tracks, each with separate frequencies and treatments to produce reference tracks and tracks responding to various measurands of interest.

FIG. 11 is a schematic representation of another embodiment of the present invention, wherein multiple acoustic tracks, each with separate frequencies, are grouped together with common treatments, to produce reference tracks and tracks responding to various measurands of interest, at least one of which contains more than one frequency acoustic wave signal.

FIG. 12 is a schematic representation of yet another embodiment of the present invention, wherein multiple two-sided differential delay line acoustic tracks, each with separate frequencies, implement measurement of temperature and at least two other parameters. Selective and conductive films are incorporated in preferential locations on this device.

FIG. 13 is a schematic representation of another embodiment of the present invention, implemented as separate die.

### III. SUMMARY OF THE PRESENT INVENTION

It should be understood that this invention is not limited to the particular methodology, protocols, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

All publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

### SOME SELECTED DEFINITIONS

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about” The term “about” when used in connection with percentages may mean ±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

According to the present invention, a surface acoustic wave (SAW) based sensor device and system for detecting the presence of and measuring the concentration of chemical and biological analytes in vapor and liquid phase can include inherent temperature compensation, higher sensitivity to surface interactions than conventional surface launched acoustic wave chemical and biological sensor devices, and the capability to operate in a wired mode or in a wireless mode with the ability to measure the distance of the sensor from the wireless transceiver (in addition to measuring temperature and the chemical and/or biological analytes of interest). This device can also monitor changes in state of thin films, including but not limited to sensing glassy to rubbery transitions in polymers, and measurement of the kinetics of chemical and/or biological processes occurring at the surface of the device. Coding (code diversity), time diversity, and frequency diversity can be included in the device structure to enable production of groups of individually identifiable sensor devices capable of operating simultaneously within the field of view of a wireless transceiver. A transceiver circuit can be configured to provide wired or wireless interrogation of the sensor device or group of devices. Wireless operation can utilize the passive nature of these sensors, or can include active components in connection with the sensors to produce active sensor modules powered by either batteries or energy harvesting techniques.

The present invention can utilize a power spectral density (PSD) of a sensor response to determine desired measurement(s) in a manner different from that previously described. The presence, location, and depth of notches in the frequency response are not utilized for measurement in the present invention as was previously described. Rather, the present invention provides device embodiments that can produce PSD signals with amplitudes that change in different portions of the frequency domain response in reaction to variations in measured parameters. At least one reference response can be incorporated in the sensor signal, allowing determination of wireless range (for wireless applications) and temperature, in addition to the other measurements of interest.

Previously demonstrated PSD temperature sensor and chemical/film sensing devices relied on two different acoustic propagation paths with slightly offset delays to produce a reflected sensor filter response that has a notch in one portion of the passband. Movement of this notch in frequency (or changes in the number of notches and notch structure) in response to changes in target parameters was useful as a measurand. In this prior application, changes in attenuation of the SAW sensor response were not a factor, as changes in target parameters produced a change in frequency of the notch, number of notches, or notch structure in the device passband. Chemical and biological sensors for both liquid and vapor phase, however, involve the use of selective coatings that can produce changes in SAW device attenuation (in addition to impacting other performance parameters). The degree of attenuation often increases with increasing interaction with the target analytes of interest, due to increased viscoelasticity, and potentially to modified electrical conductivity of the film. For certain conductive films however, the change in conductivity caused by analyte interaction can cause a decrease in attenuation. Delay (or phase or frequency) also generally changes in these sensors due to the change in velocity, but this effect can be much smaller than the change in attenuation, which can exceed 50 dB.

In order to take advantage of the large changes in attenuation observed for surface launched acoustic wave (SAW) devices coated with selective films, a new SAW sensor structure was developed that can be read by a time integrating correlator transceiver, among other techniques. The basic device structure has a minimum of two acoustic propagation paths, one of which is left bare, and the other of which is coated with a sensitive film suitable to promote interactions with one specific target analyte. The SAW elements (transducers and/or reflectors) used in certain embodiments of these sensors are either tapered, meaning that the electrode spacing varies monotonically laterally across the transducer, with the widest spacing producing the lowest frequency acoustic wave, and the smallest electrode spacing producing the highest frequency wave, or are made up of discrete frequency subtransducers arrayed laterally across the device aperture (a structure referred to as “step-tapered”). Slanted transducers with varying pitch across the passband can also be utilized. For clarity, much of the remainder of this discussion will focus on the use of tapered transducers in embodiments of the present invention, although this is not intended to limit the embodiments or to exclude ordinary untapered transducers and reflectors, dispersive transducers and reflectors, and other structures including those mentioned above.

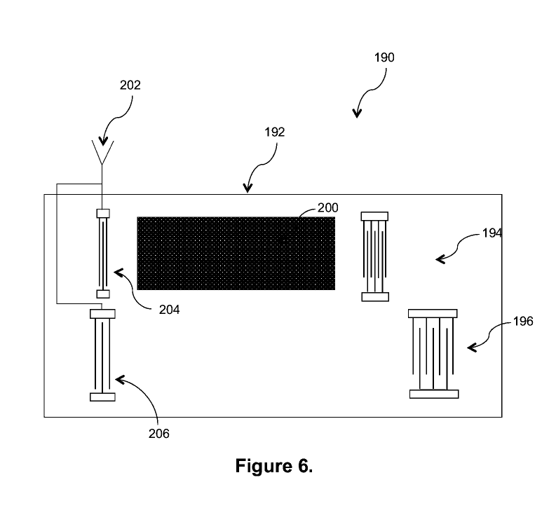

In the simplest embodiment, shown in FIG. 6, sensor 190 comprises a piezoelectric substrate 192 on which two acoustic tracks 194 and 196 operate at different frequencies. The transducers 198 in each track can be uncoded (as shown) if device identification is not required (as in the case of wired operation or single sensor operation), or coding and diversity of other kinds can be incorporated into the device structure for RFID purposes. Surface treatment and/or film 200 can be used in one of the acoustic paths to respond selectively to a parameter of interest in the environment. The amplitude and delay of the reference track 196 response can be used to evaluate sensor temperature and wireless range, while the sensing track 194 response enables measurement of the parameter of interest, for instance a chemical vapor. As shown, the device 190 receives a radio frequency wireless signal through antenna 202, which causes surface waves at different frequencies defined by transducers 204 and 206 to propagate along the die, where they are (in this example) reflected off the reflecting transducers at the far end of the die. The acoustic waves then propagate back to transducers 204 and 206, where the waves are transduced back to electromagnetic signals. These modified signals are re-transmitted through antenna 202. This embodiment is shown in FIG. 6 implemented on a single sensor die 192. Alternatively, two die could be used, a reference die and a sensing die. The two die can be mounted together in a common sample plenum, or the reference device can be hermetically sealed in one package while the sensing die is exposed to the media of interest in another package.

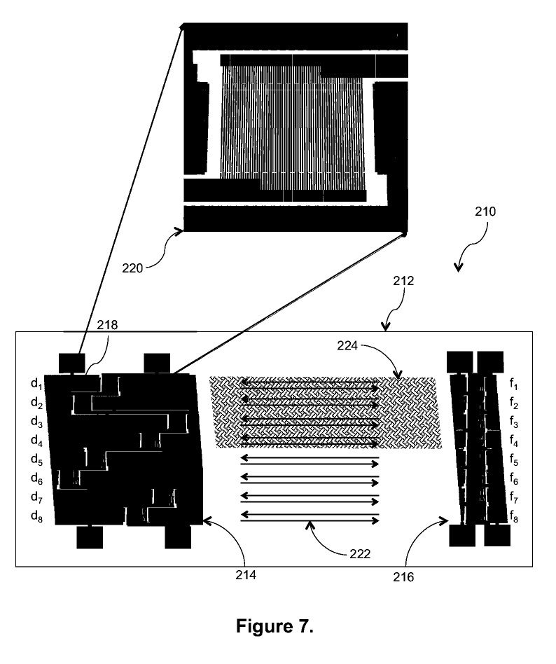

Tapered transducers have been used in high performance wideband SAW filters for decades, but have only recently been applied to SAW sensing (U.S. Pat. No. 7,434,989 to Solie; U.S. Pat. No. 7,268,662 to Hines; U.S. Provisional Patent Applications Nos. 61/512,309, 61/151,884, and 61/512,883 to Hines regarding SAW deposition monitor for ultra-thin films, July 2011 (not yet published)). FIG. 7 illustrates this device embodiment 210 of the present invention. This embodiment comprises a piezoelectric substrate 212 on which two tapered transducers 214 and 216 have been produced. Both tapered transducers in the device are implemented using sub-transducers 218, an expanded view 220 of one such subtransducer being shown in FIG. 7, which are connected to minor bus bars that are fed from major bus bars. Each sub-transducer produces an acoustic wave at a specific frequency f₁ through f₈ in a track, where it propagates and interacts with the corresponding sub-transducer in the other transducer. As shown in FIG. 7, one transducer (216) is designed so that the sub-transducers are aligned, with the centerline of each subtransducer coincident at one point along the direction of acoustic wave propagation 222 (the uncoded transducer). The second transducer (218) is designed such that each of the sub-transducers is offset by a prescribed amount along the direction of propagation, producing different acoustic wave delays d₁ through d₈ for each frequency section when the wave is received by the uncoded transducer. The delay position (time) of each frequency component of the response produces a code, hence we refer to this as the coded transducer.

The frequency response of one particular set of devices produced according to the present invention by the inventors consists of eight frequency channels, each created in one of the acoustic paths produced by the subtransducers of the tapered transducer. As shown in FIG. 7, the channels can be arranged to occur sequentially in frequency across the die. In this example, the four lower frequency channels are on one side of the die (the lower half of the die shown in FIG. 7), and the four higher frequency channels are on the other side of the die (the upper half of the die shown in FIG. 7). A film sensitive to the analyte of interest can be used to coat one portion of the propagation path between the transducers on the die. FIG. 7 shows an example where the high frequency half of the device has an acoustic propagation path coated with the sensitive film 224. The film will only affect wave propagation in the passband of the signal produced by the portion of the die that was coated. The passband response of the portion left un-coated will remain unaffected by the sensitive film, and serves as a reference path. The reference path can be used to determine approximate distance of the sensor from the transceiver (based on reference response amplitude) when used in wireless applications, and can be used to determine temperature (based on reference response delay) for both wired and wireless applications. The amplitude of both passbands (which are at different frequencies) will be affected the same way by change in location (or wireless propagation distance). Additional changes in attenuation of the response of the coated passband due to absorption of the analyte of interest can be measured relative to the reference passband response amplitude, providing a measure of the analyte of interest.

Humidity sensors according to the present invention have been demonstrated by the inventors under NASA contract NNX09CB77C. In these sensors, the lower frequency half passband (4 of 8 acoustic channels) was used as a reference response, and the high frequency half passband (the other 4 of 8 acoustic channels) was coated with a humidity sensitive nanostructured LiCl doped TiO₂ film. When exposed to increased RH levels, the lower frequency components of the response are unaffected, while the high frequency components are attenuated significantly with increasing humidity levels. A time integrating correlator-based transceiver system developed by the team measures the integrated energy in each half passband of the sensor response, and the ratio of these energies is a measure of the humidity. A combination of code diversity and time diversity was implemented in this sensor system to produce a set of 16 individually identifiable sensors that can function simultaneously in the field of view of the transceiver. Both wired and wireless humidity readings have been demonstrated using this multi-sensor measurement system.

One skilled in the art will recognize that there are a wide range of device embodiments that can be used to implement chemical and/or biological sensor devices according to the present invention. A selection of these device types is shown herein. All of these devices can be implemented in single acoustic track formats, or in multiple acoustic track formats. One or multiple acoustic paths can be used to provide reference signals, and one or multiple acoustic tracks can be used to provide measurements for target analytes. These acoustic tracks can all be at different frequencies, as shown in FIG. 7. Alternatively, two or more acoustic tracks at the same frequency can be used to form combined signals that provide added insight into the measured analytes. The acoustic paths (or selected acoustic paths) can be provided with electrical shorting pads in the deposition region and/or the reference acoustic path, if beneficial for the desired application (to separate the electrical effects of the deposited film from the mass loading and viscoelastic properties). Integral heaters can be incorporated into the device, as can integral antennas for wireless operation.

The transducers and/or reflectors described thus far are all non-dispersive, and similar embodiments could be envisioned that utilize transducers that are tapered, slanted, stepped tapered, apodized, withdrawal weighted, EWC, UDT, SPUDT, dispersive, and/or waveguide structures. Even reflective array compressor structures could be used to implement such a sensor, although such a device structure would be unnecessarily complex for most applications. All of these techniques could also be used to implement device embodiments using dispersive and harmonic techniques. In addition to implementing an attenuation-based sensor on a single substrate, it is possible to utilize multiple substrates to implement one embodiment of the present invention.

Also, one skilled in the art will recognize that these devices can be implemented on various substrate materials, and can utilize various acoustic wave propagation modes, in order to achieve performance required for specific applications. Performance suitable to measure analytes of interest in vapors and liquids; to monitor changes in thin film polymers, solids, nanostructured materials, and other films; to monitor the kinetics of reactions at the surface or the device or at the interface between an applied surface films and the adjacent environment; and to measure numerous other quantities can be achieved.

Any of a wide range of known coding techniques can be implemented in the transducers and/or reflectors. It would be understood by one versed in the art that simple on-off keying, phase modulation, pulse position modulation, and many other techniques could be used to enhance the number of codes available. The use of multiple delay “slots” within each code reflector nominal delay position is widely used to achieve increased code set size, and the use of multiple pulses per data group is also well known. Frequency diversity, code diversity, time diversity, and other know techniques can be combined to achieve sets of devices with desirable properties. Any of these techniques could be utilized in the aforementioned device embodiments to increase the number of sensors that can work together in a system. Devices utilizing such structures could be useful for RFID tag applications, where more than one deposition monitor is required within a system, and identification of individual devices is desired. In addition, combinations of these techniques may be advantageous in certain circumstances.

These embodiments can be extended to provide multiple acoustic tracks at different frequencies, either on a single die or on multiple die. One or more tracks can be used to provide reference measurements, and in some cases more than two SAW elements may be used in a single track in order to allow extraction of the desired measurement. One or more acoustic tracks can be used with sensitive coatings to measure multiple analytes simultaneously. The transceiver system architecture will be designed to include matched filters for each frequency band used in the sensor device(s).

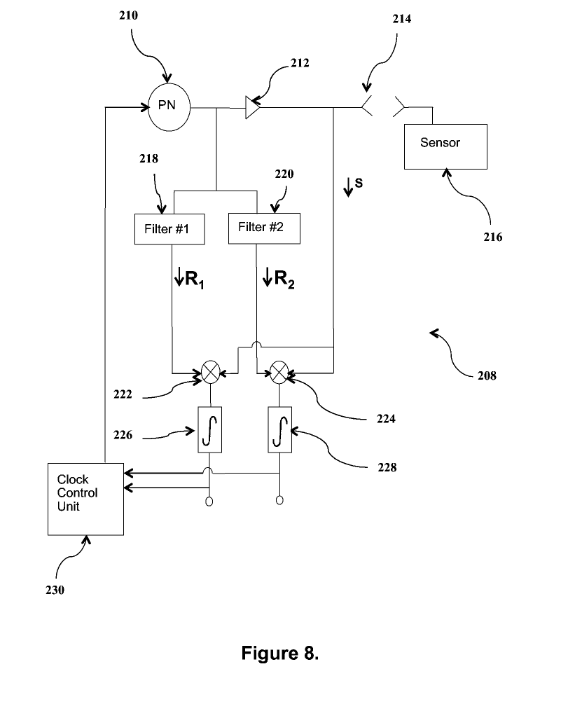

The simple schematic in FIG. 8 shows one system architecture 208 for a transceiver useful to interrogate sensors (one of which is shown schematically as 216) according to the present invention, and to interpret the response of said sensor(s). In FIG. 8, a clock control unit 230 is used to control the frequency (and the length) of a repetitive noise-like signal, indicated in this example as a pseudo-noise (PN) code 210. This signal is generally amplified 212 and transmitted (shown as wireless via antenna 214 in this example, but wired operation is also possible) to the sensor(s) 216, and the signal reflected from the sensor(s) is received by the transceiver. Toggling of the transmit and receive signals, so that the transmit signal is off when the receiver antenna is on, and vice-versa, is desirable to avoid large cross-talk signals that would occur with continuous transmit and receive operation. In addition to being sent to the sensor(s), the transmitted signal is passed through a set of reference filters, shown as 218 (filter #1) and 220 (filter #2) in FIG. 8. This produces reference signals R₁ and R₂ which are multiplied with the received reflected sensor signal S in multipliers 222 and 224. In practice, this may be performed by splitting the reference and sensor signals into in-phase and quadrature components, and performing multiplication on each relevant pair of signals. The output of these multipliers are then integrated by integrators 226 and 228 to produce output signals with amplitudes directly related to the signals being measured. The filters 218 and 220 are designed as matched filters for the sensor responses. Thus, if the sensor has two acoustic paths at different frequencies, there will be two filters with different frequencies in the reference path to correlate with the responses from the respective sensor acoustic path. If the sensor devices contain codes, the reference filters will likewise contain the same codes. An arbitrary number of acoustic tracks can be implemented on the sensor (or sensors), and a matching set of reference path filters will be needed to read and interpret the responses of this set of sensors. The reference filters can be implemented in hardware or as a software radio, and can be used to interpret the combined response of a set of wireless sensors, to read and obtain identification and measurement data from each sensor. Amplitude levels, and ratios of these levels, from different acoustic tracks and sensors can be useful in making specific measurements, as can other sensor device performance parameters, and system parameters such as clock control unit settings required to synchronize the system with a given sensor. This preferred embodiment of a transceiver system is distinct from that taught in U.S. Pat. No. 7,434,989 to Solie. In the present invention, the reference filters comprise filters that correspond to subdivisions of the frequency spectrum reflective of the subdivision of the frequency spectrum in the sensor that provides reference and sensing acoustic paths. In Solie '989, the entire passband of the sensor was functional in making the measurement of interest, rather than having a reference path and a sensing path within the sensor. In the transceiver system of Solie '989, the reference path filters monitor the movement of energy into and out of all of the frequency sub-bands as a notch (or notches) move in frequency within the passband. In the present invention, one (or more) reference filter(s) provide reference measurement(s), and the other reference filter(s) provide independent relative measurements of different analytes of interest. The present invention is much more suitable for application to multiplexed testing for several analytes than that previously described herein and those in the literature.

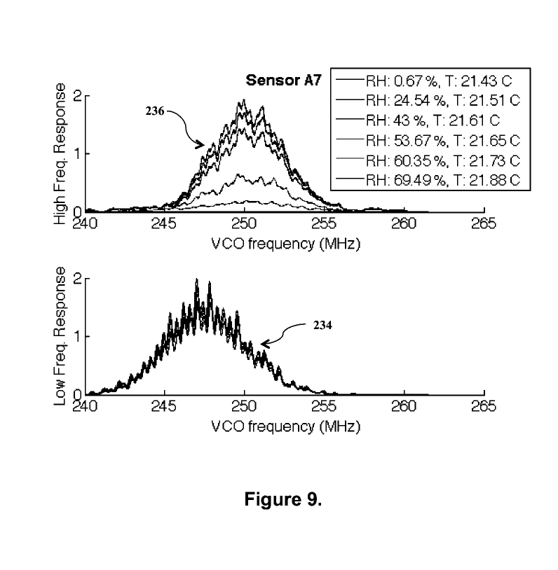

FIG. 9 shows experimental data from a two-acoustic track coded SAW humidity sensor according to the present invention. The low frequency acoustic track, which contains one code, provides a reference response, and the lower plot 234 in FIG. 9 is the output of the corresponding receiver module (after being multiplied with the reference filter passed through a matched filter and integrated) as a function of VCO tuning frequency. This response is relatively independent of humidity. The upper curve 236 in FIG. 9 is the output of the high frequency receiver module with a reference filter having a code matching that of the sensor of interest. In this system, 16 individually identifiable sensors were implemented using code diversity and time diversity, and were measured with the transceiver system.

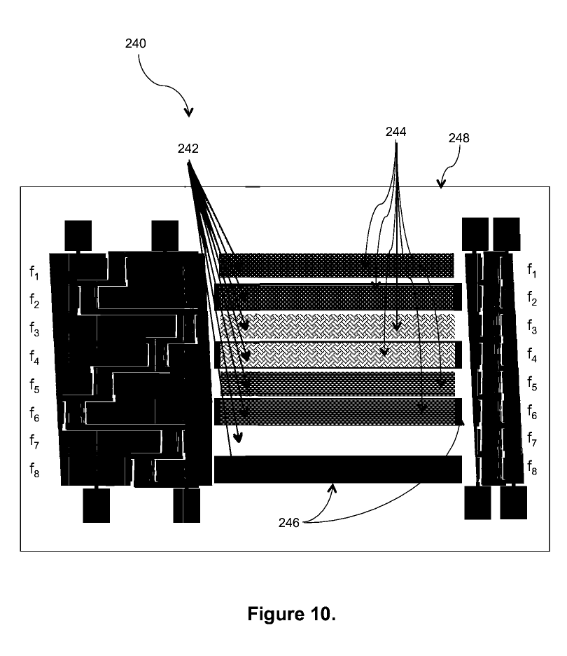

In order to extract information about the film being deposited, it is worthwhile to measure conductive effects as well as effects of mass loading and viscoelasticity, and to separate these effects from one another to the extent possible. Inclusion of a temperature sensor device allows extraction of the effects of temperature, which can be done using the delay of the integral reference track responses, or with separate temperature sensing elements incorporated. Inclusion of multiple differential delay lines, preferably operable in different frequency ranges, with different coating treatments allows separation of conductive effects from those involving mass loading and viscoelasticity. FIG. 10 shows another embodiment of a sensor 240 according to the present invention comprising multiple acoustic tracks 242 disposed on piezoelectric substrate 248, each with separate frequencies f₁ through f₈ and individual treatments 244 to produce reference tracks and tracks responding to various measurands of interest. The solid shaded regions shown in four of the acoustic tracks of FIG. 10, two of which are indicated by 246, are conductive films deposited in a portion of the acoustic wave propagation path in each of these tracks. The “bare” acoustic track at frequency f₇ is one reference track in the illustrated device. These conductive coatings short out the electrical field at the surface of the device, causing changes in the electrical properties of films deposited on the surface to have no effect on the wave propagating in that region. Films 244 that are sensitive or reactive to specific analytes of interest can be deposited on portions of the acoustic wave propagation path in selected acoustic tracks. These films can be any of a wide range of known materials, including but not limited to polymers, self-assembled monolayers, metals, nanostructured thin films, composite films containing carbon nanotubes and other nanoparticles, and composite films containing multiple layers and attached molecules and biological moieties such as DNA, RNA, cells or cell fragments, antibodies, antigens, bacteria, enzymes, and various biomolecules such as proteins, among others. These films can respond to chemical and/or biological analytes in the fluid surrounding the sensor with changes in mass loading, viscoelastic film properties, and electrical properties. Each of these changes can cause a modification in acoustic wave propagation characteristics that is measurable.

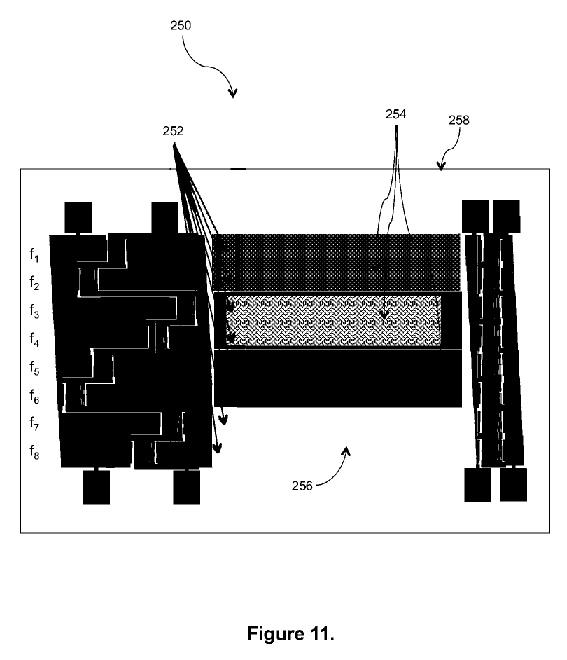

The example shown in FIG. 10 includes a single “bare” (uncoated) acoustic wave track, but multiple uncoated tracks can be incorporated into the sensor to provide differential delay measurements useful for temperature sensing and related functions. Also, while FIG. 10 shows sensitive coatings 244 applied in pairs to bare acoustic wave tracks and to electrically shorted acoustic wave tracks, this may not be desirable for films that do not have electrical properties that vary significantly with exposure. In addition, it may be desirable to have a single coating applied to multiple acoustic paths (with or without shorting layers) that operate at the same or at different frequencies. Multiple reference paths may be needed at the same frequency or at different frequencies to provide appropriate reference information to allow interpretation of data from multiple sensing tracks with various films, operating frequencies, and other properties. FIG. 11 shows by way of example another embodiment of the present invention wherein sensor 250 comprises tapered and coded transducers as in FIGS. 7 and 10, operative to generate, receive, and/or reflect acoustic waves in eight parallel acoustic tracks at frequencies f₁ through f₈. In this embodiment, the eight acoustic channels 252, which operate at different frequencies, are treated such that two channels propagate waves beneath each of the three films 254 deposited in the respective acoustic propagation paths. In this example, there are two selective films (shown by the dotted rectangle in the upper two channels and the cross-hatched rectangle in the second two channels. The solid shaded rectangle in the third pair of channels from the top (which is also present under the sensitive layer in the second pair of channels from the top) is a conductive film intended to eliminate electrical effects from the film response (from the cross-hatched film) and to provide a reference response with an electrically shorted surface. The bottom two channels, indicated by 256, are reference channels. While the channel frequencies are shown in FIG. 11 to vary monotonically from top to bottom of the die 258, it would be understood by one skilled in the art that this sequence is but one of many possible arrangements. In fact, the frequencies of the different channels need not be in order, and can jump considerably from track to track. Incorporation of harmonic responses, with one channel at a given frequency and one or more other channels at harmonics of that frequency, may be useful to provide additional information. In such a configuration, it may be beneficial to utilize multiple frequencies to characterize a single film layer, at the same or different film thicknesses.

It would be clear to one skilled in the art that films with properties that vary over time with exposure to certain environments could be used in the present invention to implement monitoring devices. As one concrete example, a corrosion monitor could be constructed that utilizes multiple thin films of the same or different materials deposited on a multichannel device. These films can be designed to corrode at different rates in a given environment, so that the changes observed in acoustic wave propagation in each channel can be correlated to the rate at which a relevant material (such as steel pipe) would corrode. This approach utilizes the films as a sacrificial material, and provides a sequential series of measurements to assess how far corrosion has progressed in the materials of interest. This example also highlights the fact that sensors and monitoring devices according to the present invention can be implemented utilizing reversible, equilibrium chemical or biochemical processes to produce real-time monitors for analytes in the environment of the sensor; or alternatively they can be implemented employing irreversible physical, chemical, biochemical processes to provide alarm or dosimeter-like monitoring devices.

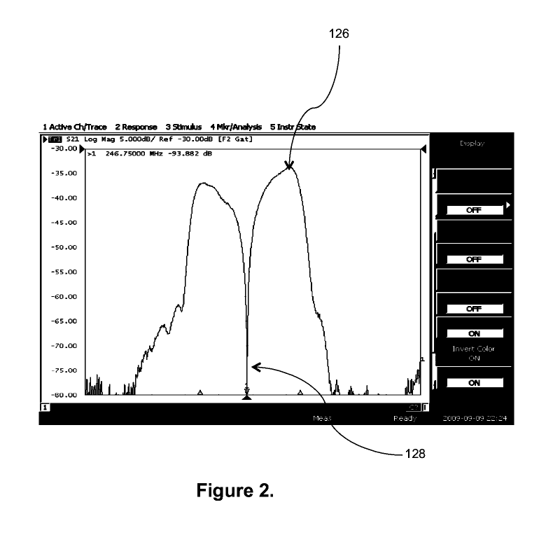

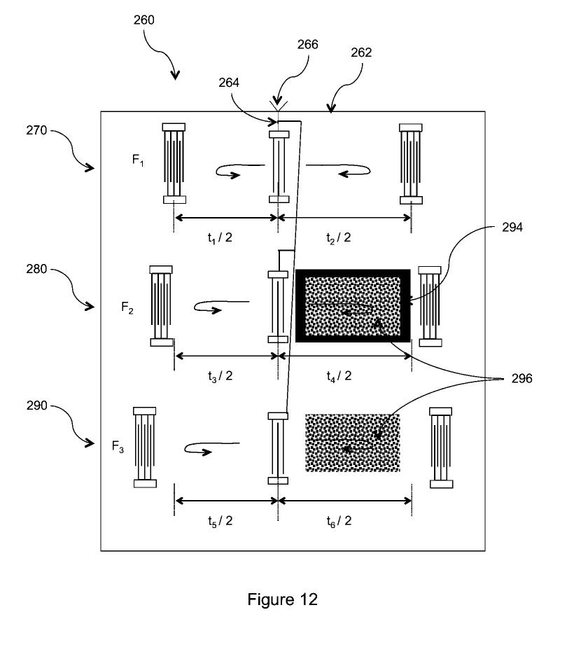

Thus far, all of the embodiments shown have been “single-sided” in that the acoustic wave propagation from only one side of the transducer has been utilized in device operation. This is beneficial in the examples shown due to the delay-coded nature of one of the transducers. The embodiments shown in FIGS. 7, 10, and 11 all are intended to operate in a transmission “S21” mode, where the signal is measured propagating between the transducers in a single pass. In practice, these devices have been built as passive wireless reflective sensors by exploiting the reciprocal nature of SAW devices—the “S12” and “S21” (or forward and reverse) responses of a SAW device are identical. Thus, one antenna can be connected electrically in parallel to the two transducers of FIGS. 7, 10, and 11, and the signals passing from left to right and from right to left will be identical, and will add to produce the device output. However, unless unidirectional transducers are used, standard SAW transducers are bidirectional and launch acoustic waves in two directions. FIG. 12 shows another preferred embodiment of a composite sensing device 260 according to the present invention that utilizes both bidirectional and reflective transducer operation. Sensor device 260 consists of piezoelectric substrate 262, on which a minimum of three acoustic tracks have been formed by SAW elements. The embodiment of FIG. 2 includes three acoustic channels 270, 280, and 290, which have SAW elements designed to operate in passbands centered at frequencies F₁, F₂, and F₃. These can be chosen coincident, but separating the three operating frequencies to produce three separate passbands may be advantageous to extract additional information from the measurements. These three channels can be spatially separated, or can be subchannels defined transversely across the aperture of one or more transducers. The three input/output transducers can be fed electrically in common, as shown with feed 264, which is connected electrically to antenna 266, or can be accessed separately. Each channel in this example shows outer SAW elements acting as reflectors, but once again either reflectors or transducers, or a mixture of both can be used. Device 260 includes a conductive film 294 in one acoustic path of one channel. This conductive pad shorts out the electric field at the surface of the device, meaning that any film deposited on this region will modify the SAW propagation only due to mass loading and viscoelastic film properties. Electrical properties of the film will not affect the SAW in this region. Shown in FIG. 12 are two rectangular film regions 296, on which a sensitive film has been deposited on the acoustic propagation paths of one side of acoustic channel 280, which has a metal shorting pad on it, and one side of acoustic channel 290, which is bare substrate. The third acoustic channel, 270, is used to measure temperature. This structure allows the effects of electrical film properties to be determined from the response of channel 280, with the response of mass loading and viscoelastic properties from channel 290 subtracted, and the temperature response from channel 270 taken into consideration. The times t₁, t₂, t₃, t₄, t₅, and t₆ can be selected to produce the desired differential delay configurations and sensitivities desired in each acoustic channel.

It should be noted that FIG. 12 includes a “bare” reference response in each acoustic channel on the device. In alternate embodiments that are within the scope of the present invention, there may be multiple acoustic tracks at the same frequency, in addition to other tracks at different frequencies. Also, it may not be necessary to leave all the reference tracks “bare”, and other coatings (such as SiO₂ or Si₃N₄ for temperature compensation or chemical protection) may be desirable on one or more parts of the device. Multiple reference tracks may be desirable in certain cases.

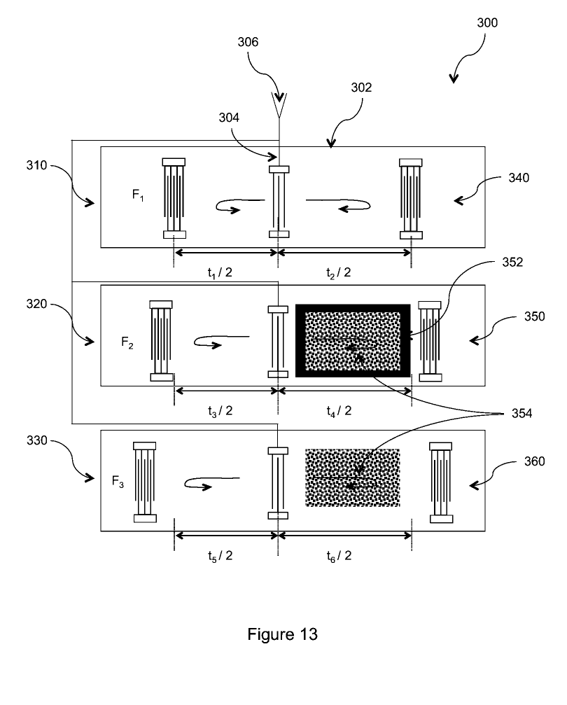

FIG. 13 shows another embodiment according to the present invention, in which sensor 300 comprises three acoustic differential delay lines 310, 320, and 330, which have been implemented on three separate die 340, 350, and 360, each of which comprises a piezoelectric substrate 302 and at least three SAW elements, at least one of which must be a transducer. In the embodiment shown, three input/output transducers are fed by a common conductor 304 which is electrically connected to antenna 306. Signals at frequencies F₁, F₂, and F₃ are launched by the central input transducers to both the left and right, and propagate until they reflect from the at least two outer SAW elements (shown as transducers in this example) and propagate back to the center transducers, which convert the acoustic wave back into an electrical signal that is transmitted out through antenna 306. Conductive film 352 and sensitive film 354 have the same function as in FIG. 12.

One skilled in the art will recognize that there are a wide range of device embodiments that can be used to implement sensor devices according to the present invention. A selection of these device types has been shown. However, deviations from the examples included herein are within the scope of the present invention. All of these devices can be implemented in single-track formats, or in multiple acoustic track formats. They can be provided with electrical shorting pads in the deposition region(s) or portions thereof and/or the reference acoustic path(s) or portions thereof, if beneficial for the desired application (to separate the electrical effects of the deposited film from the mass loading and viscoelastic properties). These devices can utilize single sided and double sided die, differential delay lines and non-differential delay lines, or a mixture of the two within a single device. Differential delay lines can be implemented in a single or double-sided fashion, and can be extended to provide multiple differential delay signals in a single track (of one or more sides). Any of the devices shown can be implemented as a single die or as multiple separate die, each with one or more of the acoustic reference and/or measurement tracks. If multiple die are used, they may be of the same or different substrate materials and electrode materials. Multiple die may be packaged together, or selected die can preferentially be packaged separately, for example to serve as a hermetically sealed reference device. If implemented in separate devices, the reference device need not necessarily be co-located with the sensing devices.

The transducers and/or reflectors described thus far are all non-dispersive, and similar embodiments could be envisioned that utilize transducers that are tapered, slanted, stepped tapered, apodized, withdrawal weighted, EWC, UDT, SPUDT, dispersive, and/or waveguide structures. All of these techniques could also be used incorporating dispersive and harmonic techniques. For example, use of chirped transducers to provide processing gain may be beneficial, as is widely recognized. Harmonic techniques may be utilized by incorporating nonlinear elements into the device. Alternatively, high frequency SAW signals may be made to interact with SAW elements at the wave frequency and at sub-harmonics of that frequency, depending on the electrode structures used in the SAW elements used.

Also, one skilled in the art will recognize that these devices can be implemented on various substrate materials, and can utilize various acoustic wave propagation modes, in order to achieve performance required for specific applications. Performance to measure deposition of vapors, liquids, polymers, solids, and numerous other quantities can be achieved. Measurement of films deposited at high temperatures can be accomplished using langasite, langanite, langatate, or other substrate capable of operating at high temperatures. In order to measure conductive films, a substrate with high electromechanical coupling coefficient is preferred. Electrodes and busbars of SAW elements can be made from materials appropriate to survive the application environment, including the ability to withstand high or low temperatures, and chemical environments. Measurement of chemical and biological analytes in liquids, or measurement of physical properties of liquids such as viscosity, may benefit from use of a two-sided device such as a FPW or LG-SH-APM device, wherein a two-surfaced die is used. In this case, the electrodes are on one surface of the device (arbitrarily referred to as the “bottom”) while the fluid handling is on the opposite (“top”) surface of the device. Alternate wave modes may be more useful for specific applications.

Any of a wide range of known coding and other diversity techniques can be implemented in the transducers and/or reflectors. It would be understood by one versed in the art that simple on-off keying, phase modulation, pulse position modulation, and many other techniques could be used to enhance the number of codes available. The use of multiple delay “slots” within each code reflector nominal delay position is widely used to achieve increased code set size, and the use of multiple pulses per data group is also well known. Frequency diversity, code diversity, time diversity, and other know techniques can be combined to achieve sets of devices with desirable properties. Any of these techniques could be utilized in the aforementioned device embodiments to increase the number of sensors that can work together in a system with individually identifiable devices. Devices utilizing such structures could be useful for RFID tag sensing applications, where more than one sensor is required within a system, and identification of individual devices is desired. In addition, it would be understood by one skilled in the art that sensor-tag application of the present invention is possible, wherein external sensing devices can be connected to one or more specific SAW elements to measure additional external parameters. Variations in the impedance other properties (voltage, etc.) of the external sensor can then be read through the SAW device. Combination devices that include measurements made with integral sensitive films, in addition to external sensor device loads, are also within the scope of the present invention.

### IV. CONCLUSION

The broad nature of the invention described here are clear, and one skilled in the art will understand that there are a variety of device configurations that can be generated using combinations of one or more of the techniques discussed. The inventions described herein and illustrated in the figures provide device embodiments capable of measuring a wide range of chemical and biological analytes, changes in surface coatings, and reaction kinetics. The present invention can be interrogated using, among other techniques, a preferred time integrating correlator system such as that disclosed above. While some preferred forms and embodiments of the invention have been illustrated and described, it will be apparent to those of ordinary skill in the art that various changes and modification may be made without deviating from the inventive concepts set forth above.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

What is claimed is:

1. A surface acoustic wave sensor device, comprising
(a) a piezoelectric substrate;
(b) at least one first transducer and one second transducer arranged in separate first and second acoustic tracks on at least a portion of said piezoelectric substrate wherein said first and second transducers have electrode structures so as to be capable of generating and receiving acoustic waves at two different frequencies;
(c) at least one third surface acoustic wave element formed on said piezoelectric substrate and spaced from said first transducers along the direction of acoustic wave propagation in the first acoustic track at a distance to create a first acoustic delay, said at least one third surface acoustic wave element comprising electrode structures capable of interacting with acoustic waves at frequencies that correspond to the frequencies generated by said first transducer;
(d) at least one fourth surface acoustic wave element formed on said piezoelectric substrate and spaced from said second transducer along the direction of acoustic wave propagation in the second acoustic track at a distance to create a second acoustic delay, said at least one fourth surface acoustic wave element comprising electrode structures capable of interacting with acoustic waves at frequencies that correspond to the frequencies generated by said second transducer;
(e) wherein said third and fourth acoustic wave elements interact with the acoustic waves launched by said first and second transducers respectively, to produce first and second signals occurring at different frequencies and at said first and second acoustic delays, respectively;
(f) wherein a region of the acoustic propagation path of at least one of the first or second acoustic track is treated with a surface treatment (referred to as a “film” hereinafter) that has properties that change in response to analytes of interest in the fluid environment surrounding the sensor; and
(g) wherein changes in the film properties produce changes in the propagation of the acoustic wave in the region of the device coated with the film; and
(h) wherein the combined response of said first and second signals effect a composite signal comprising two different frequency domain portions, the relative amplitudes of which provide measurement of at least one sensed parameter.

2. A surface acoustic wave sensor device according to claim 1, further comprising
(a) at least one additional acoustic track;
(b) wherein each track is defined by at least one transducer and one or more additional surface acoustic wave elements formed on said piezoelectric substrate and spaced from along the direction of acoustic wave propagation in the track at a distance to create an acoustic delay;
(c) wherein, within each track said transducer has electrode structures so as to be capable of generating and receiving acoustic waves over a defined range of frequencies, which can differ from track to track;
(d) wherein said at least one additional surface acoustic wave element in each track comprise electrode structures capable of interacting with acoustic waves at frequencies that correspond to the frequencies generated by said transducer in the same track;
(e) wherein at least one selected portion of the acoustic propagation path of a subset of the acoustic tracks in the device is left without a surface treatment to provide a reference response;
(f) wherein at least one surface treatment (film) is effected on selected portions of the acoustic propagation path of a subset of said at least one of the additional acoustic tracks; said film having properties that change in response to analytes of interest in the fluid environment surrounding the sensor; and
(g) wherein changes in the film properties produce changes in the propagation of the acoustic wave in the region of the device coated with the film; and
(h) wherein the combined response of the signals from all the acoustic tracks effect a composite signal comprising two different frequency domain portions, the relative amplitudes of which provide measurement of at least one sensed parameter.

3. A surface acoustic wave sensor device according to claim 2, further comprising at least one portion of the wave propagation region of one of said acoustic tracks that is coated with a conductive film operable to short out the electric field at the surface of the device.

4. A surface acoustic wave sensor device according to claim 2, further comprising at least one portion of the wave propagation region of one of said acoustic tracks that is coated with a partially- or semi-conductive film operable to interact with the electric field at the surface of the device.

5. A surface acoustic wave sensor device according to claim 1, wherein the frequency, delay, and/or phase of device responses in different frequency bands are used in addition to the amplitude of these responses, to provide additional information on measurands of interest.

6. A surface acoustic wave sensor device according to claim 2, wherein the frequency, delay, and/or phase of device responses in different frequency bands are used in addition to the amplitude of these responses, to provide additional information on measurands of interest.

7. A surface acoustic wave sensor device according to claim 2, wherein some subset of said transducers are tapered or step-tapered.

8. A surface acoustic wave sensor device according to claim 2, wherein some subset of said transducers are slanted.

9. A surface acoustic wave sensor device according to claim 2, wherein some subset of said transducers are dispersive.

10. A surface acoustic wave sensor device according to claim 2, wherein some subset of said SAW elements are coded.

11. A surface acoustic wave sensor device according to claim 10, wherein said coded SAW elements utilize direct sequence spread spectrum coding.

12. A surface acoustic wave sensor device according to claim 10, wherein said coded SAW elements utilize discrete frequency coding.

13. A surface acoustic wave sensor device according to claim 10, wherein said coded SAW elements utilize spread spectrum pulse dispersion coding.

14. A surface acoustic wave sensor device according to claim 10, wherein said coded SAW elements utilize a combination of coding techniques selected from discrete frequency coding, direct sequence spread spectrum coding, pulse dispersion coding, and time diversity.

15. A surface acoustic wave sensor device according to claim 2, wherein a subset of said acoustic tracks are implemented on multiple, physically separate piezoelectric substrates.

16. A surface acoustic wave sensor device according to claim 2, wherein a subset of said acoustic tracks implemented differential delay line structures.

17. A surface acoustic wave sensor device according to claim 16, wherein a subset of said differential delay line structures are implemented in a double-sided die configuration with a central transducer common to both acoustic responses.

18. A surface acoustic wave sensor device according to claim 16, wherein a subset of said differential delay line structures are implemented in a single-sided die configuration with a transducer at one side of the device common to both acoustic responses.

19. A surface acoustic wave sensor device according to claim 2, wherein a subset of said surface acoustic wave elements are connected to external sensors that vary in impedance in response to measurands in the environment of the sensor.

20. A surface acoustic wave sensor device according to claim 2, wherein the sensor measures a physical property in addition to other parameters being measured.

21. A surface acoustic wave sensor device according to claim 22, wherein the additional physical property the sensor measures is fluid viscosity.

22. A surface acoustic wave sensor device according to claim 2, wherein the additional physical property the sensor measures is temperature.

23. A surface acoustic wave sensor device according to claim 2, wherein the sensor is capable of measuring multiple chemical and/or biological analytes and at least one physical property.

24. A surface acoustic wave sensor device according to claim 2, wherein the device is operable with acoustic wave moped suitable to monitor gaseous environments.

25. A surface acoustic wave sensor device according to claim 2, wherein the device is operable with acoustic wave modes suitable to monitor liquid environments.

26. A surface acoustic wave sensor device according to claim 2, wherein the surface treatment incorporates at least one biologically specific moiety.

27. A surface acoustic wave sensor device according to claim 2, wherein the surface treatment incorporates at least one biologically specific moiety.

28. A surface acoustic wave sensor device according to claim 2, wherein said surface acoustic wave sensor device can be used to provide real-time monitoring for the reaction kinetics of chemical, biological, or biochemical reactions occurring on the surface of the device.

29. A surface acoustic wave sensor device according to claim 2, wherein said surface acoustic wave sensor device can be used to provide real-time monitoring for the changes in the properties of films existent on the surface of the device.
